(19) United States
(12) Patent Application Publication
(10) Pub. No.: US 2020/0070845 A1
(43) Pub. Date: Mar. 5, 2020

(54) Positioning Drift Detecting Method, Apparatus, Device and Computer Readable Storage Medium

(71) Applicant: Baidu Online Network Technology (Beijing) Co., Ltd., Haidian District Beijing (CN)

(72) Inventors: Wuzhao Zhang, Haidian District Beijing (CN); Lei Zhang, Haidian District Beijing (CN); Qijuan Yin, Haidian District Beijing (CN); Xiaoyan Wang, Haidian District Beijing (CN); Baisheng Wang, Haidian District Beijing (CN); Zhuo Chen, Haidian District Beijing (CN)

(73) Assignee: Baidu Online Network Technology (Beijing) Co .. Ltd., Haidian District Beijing (CN)

(21) Appl. No.: 16/514,939

(22) Filed: Jul. 17, 2019

(30) Foreign Application Priority Data
Aug. 31, 2018 (CN) 201811008493.8

(51) Int. Cl. B60W 40/10; B60W 30/18; B60W 30/06

(52) U.S. Cl. CPC B60W 40/10; B60W 30/18; B60W 2400/00; B60W 2720/106; B60W 30/06

(57) ABSTRACT

The present disclosure provides a positioning drift detecting method, apparatus, device and computer readable medium, where the method includes: obtaining driving information of a driverless vehicle at a current time point; predicting an estimated driving range of the driverless vehicle at a next time point according to the driving information at the current time point, where there is a preset time interval between the current time point and the next time point; obtaining driving information of the driverless vehicle at the next time point; and determining whether the driving information at the next time point is within the estimated driving range, and performing a corresponding operation according to a determination result. As a result, it is possible to accurately determine whether or not a drift occurs currently, thereby preventing a driving accident of the driverless vehicle and improving a driving safety of the driverless vehicle.

### CROSS-REFERENCE TO RELATED APPLICATION

This application claims priority to Chinese Patent Application No. 201811008493.8, filed on Aug. 31, 2018, which is hereby incorporated by reference in its entirety.

### TECHNICAL FIELD

The present disclosure relates to the field of self-driving vehicles, and in particular, to a positioning drift detecting method, apparatus and device, and a computer readable storage medium.

### BACKGROUND

A driverless vehicle is a kind of smart vehicle, also known as a wheeled mobile robot, and known as self-driving vehicle for short. It mainly relies on a computer system-based smart pilot in the vehicle to realize driverless driving. Since the driverless vehicle has no user to control, it is necessary to plan a driving route according to a current positioning information of the driverless vehicle and a current road condition information in real time. Therefore, a positioning of the driverless vehicle is an important factor for a normal operation of the driverless vehicle.

In practical applications, if the driverless vehicle is not accurately positioned, a state of the driverless vehicle will be unknown, which will cause major safety problems. Therefore, how to accurately position the driverless vehicle, timely find a positioning drift and report a secure node has become a technical problem that needs to be solved urgently.

### SUMMARY

The present disclosure provides a positioning drift detecting method, apparatus, device and a computer readable storage medium, which are used for solving the technical problem that a driving accident can be caused to a driverless vehicle due to inaccurate positioning of the driverless vehicle.

A first aspect of the present disclosure provides a positioning drift detecting method, including:

obtaining driving information of a driverless vehicle at a current time point;

predicting an estimated driving range of the driverless vehicle at a next time point according to the driving information at the current time point, where there is a preset time interval between the current time point and the next time point;

obtaining driving information of the driverless vehicle at the next time point; and

determining whether the driving information at the next time point is within the estimated driving range, and performing a corresponding operation according to a determination result.

Another aspect of the present disclosure provides a positioning drift detecting apparatus, including:

a first obtaining module, configured to obtain driving information of a driverless vehicle at a current time point;

a predicting module, configured to predict an estimated driving range of the driverless vehicle at a next time point according to the driving information at the current time point, where there is a preset time interval between the current time point and the next time point;

a second obtaining module, configured to obtain driving information of the driverless vehicle at the next time point; and

a processing module, configured to determine whether the driving information at the next time point is within the estimated driving range, and perform a corresponding operation according to a determination result.

Yet another aspect of the present disclosure provides a positioning drift detecting device, including a memory and a processor;

the memory is configured to store instructions that are executable by the processor;

where the processor is configured to perform the positioning drift detecting method as described above.

Yet another aspect of the present disclosure provides a computer readable storage medium, where the computer readable storage medium stores computer executable instructions, the computer executable instructions are configured to implement the positioning drift detecting method as described above when being executed by a processor.

The positioning drift detecting method, apparatus, device and computer readable medium provided by the present disclosure, by obtaining driving information of a driverless vehicle at a current time point; predicting an estimated driving range of the driverless vehicle at a next time point according to the driving information at the current time point, where there is a preset time interval between the current time point and the next time point; obtaining driving information of the driverless vehicle at the next time point; and determining whether the driving information at the next time point is within the estimated driving range, and performing a corresponding operation according to a determination result, can accurately determine whether or not a drift occurs currently, thereby preventing the driving accident of the driverless vehicle and improving a driving safety of the driverless vehicle.

### BRIEF DESCRIPTION OF DRAWINGS

In order to illustrate the technical solutions of embodiments of the present disclosure, or the technical solutions of the prior art, more clearly, the drawings used in the embodiments of the present disclosure or the prior art will be briefly described below. It is apparent that the drawings in the following description are only some embodiments of the present disclosure; other drawings may be obtained by those of ordinary skill in the art without any creative efforts.

FIG. 1 is a schematic flowchart of a positioning drift detecting method according to a first embodiment of the present disclosure;

FIG. 2 is a schematic flowchart of a positioning drift detecting method according to s second embodiment of the present disclosure;

FIG. 3 is a schematic structural diagram of a positioning drift detecting apparatus according to a third embodiment of the present disclosure;

FIG. 4 is a schematic structural diagram of a positioning drift detecting apparatus according to a fourth embodiment of the present disclosure; and

FIG. 5 is a schematic structural diagram of a positioning drift detecting device according to a fifth embodiment of the present disclosure.

### DESCRIPTION OF EMBODIMENTS

For the purpose of making objects, the technical solutions and advantages of the embodiments of the present disclosure clearer, the technical solutions in the embodiments of the present disclosure will be described clearly and thoroughly in conjunction with the drawings in the embodiments of the present disclosure. It is apparent that the embodiments that are described are part of, rather than all of, the embodiments of the present disclosure. All other embodiments obtained based on the embodiments of the present disclosure shall fall within the protection scope of the present disclosure.

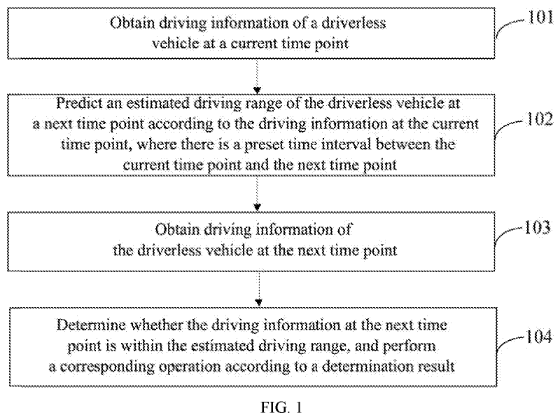

FIG. 1 is a schematic flowchart of a positioning drift detecting method according to a first embodiment of the present disclosure. As shown in FIG. 1, the method includes:

Step 101: obtain driving information of a driverless vehicle at a current time point.

An execution subject of this embodiment is a positioning drift detection apparatus. In this implementation, if the driverless vehicle is not accurately positioned, a state of the driverless vehicle will be unknown, which will cause major safety problems. Therefore, how to accurately position the driverless vehicle, timely find a positioning drift and report a secure node has become a technical problem that needs to be solved urgently. Specifically, the driverless vehicle uploads currently collected driving information every preset time interval. The driving information may be obtained by a functional module such as a Global Positioning System (GPS), a radar module, a camera device, and the like. Correspondingly, the positioning drift detecting apparatus can receive the driving information currently collected by the driverless vehicle.

Step 102: predict an estimated driving range of the driverless vehicle at a next time point according to the driving information at the current time point, where there is a preset time interval between the current time point and the next time point.

In this implementation, since the driverless vehicle uploads the currently collected driving information every preset time interval, in order to determine whether the driverless vehicle has a positioning drift currently, the positioning drift detecting apparatus may predict the estimated driving range of the driverless vehicle at the next time point according to the time interval and the driving information. It can be understood that if the driverless vehicle appears in the estimated driving range at the next time point, it indicates that the driverless vehicle is currently running normally, and no positioning drift occurs. If the driverless vehicle is not within the estimated driving range at the next time point, it indicates that a positioning drift occurs currently for the driverless vehicle. In order to improve the safety of the driverless vehicle, it is necessary to adjust the driverless vehicle.

Step 103: obtain driving information of the driverless vehicle at the next time point.

In this implementation, in order to determine whether the driverless vehicle has a positioning drift currently, after the time interval from receiving the driving information of the driverless vehicle at the current time point, actual driving information of the driverless vehicle at the next time point may be obtained, where the driving information may be obtained by a functional module such as a GPS, a radar module, a camera device, and the like.

Step 104: determine whether the driving information at the next time point is within the estimated driving range, and perform a corresponding operation according to a determination result.

In this embodiment, after predicting the estimated driving range of the driverless vehicle at the next time point and determining the actual driving information of the driverless vehicle at the next time point, it can be determined whether the actual driving information at the next time point is within the estimated driving range, and take the corresponding measures according to the determination result to ensure that the driverless vehicle can drive safely.

The positioning drift detecting method provided by the present embodiment, by obtaining driving information of a driverless vehicle at a current time point; predicting an estimated driving range of the driverless vehicle at a next time point according to the driving information at the current time point, where there is a preset time interval between the current time point and the next time point; obtaining driving information of the driverless vehicle at the next time point; and determining whether the driving information at the next time point is within the estimated driving range, and performing a corresponding operation according to a determination result, can accurately determine whether or not a drift occurs currently, thereby preventing a driving accident of the driverless vehicle and improving a driving safety of the driverless vehicle.

Specifically, the driving information includes a positioning of the driverless vehicle in a world coordinate system, a speed orientation, an angular velocity and a driving speed. Based on the foregoing embodiment, the method includes:

obtain driving information of a driverless vehicle at a current time point;

calculate an orientation range of the driverless vehicle at a next time point according to a current speed orientation, an angular velocity and the preset time interval;

calculate a driving displacement of the driverless vehicle at the next time point according to the driving speed and the preset time interval;

calculate a positioning range of the driverless vehicle in the world coordinate system at the next time point according to the orientation range, the driving displacement and the positioning of the driverless vehicle in the world coordinate system, and take the positioning range in the world coordinate system as the estimated driving range;

obtain driving information of the driverless vehicle at the next time point; and

determine whether the driving information at the next time point is within the estimated driving range, and perform a corresponding operation according to a determination result.

In this embodiment, the driving information specifically includes the positioning of the driverless vehicle in the world coordinate system, the speed orientation, the angular velocity and the driving speed. Therefore, after receiving the driving information of the driverless vehicle at the current time point, the orientation range of the driverless vehicle at the next time point may be predicted according to the current speed orientation, the angular velocity and the preset time interval. Specifically, a product of the angular velocity and the time interval may be used to obtain a deflection angle of the driverless vehicle at the next time point. In addition, the driving displacement of the driverless vehicle at the next time point may be calculated according to the current driving speed of the driverless vehicle and the preset time interval. Specifically, the driving displacement may be obtained by multiplying the driving speed by the preset time interval. After obtaining the orientation range and the driving displacement, the estimated driving range of the driverless vehicle at the next time point can be roughly obtained. In an embodiment, an estimated positioning range of the driverless vehicle in the world coordinate system at the next time point may be calculated according to the orientation range, the driving displacement and the current positioning of the driverless vehicle in the world coordinate system, and taking the positioning range as the estimated driving range. Furthermore, actual driving information of the driverless vehicle at the next time point is obtained; and it is determined whether the actual driving information at the next time point is within the estimated driving range. If the actual driving information of the next time point is within the estimated driving range, it indicates that the driverless vehicle is currently running normally and no positioning drift occurs. If the actual driving information of the next time point is not within the estimated driving range, it indicates that the driverless vehicle has a positioning drift currently. In order to improve the safety of the driverless vehicle, it is necessary to adjust the driverless vehicle.

The positioning drift detecting method provided by this embodiment, by calculating an estimated driving range of the driverless vehicle at a next time point according to a positioning in a world coordinate system, a speed orientation, an angular velocity and a driving speed, can accurately determine whether the driverless vehicle has a positioning drift currently and improving the driving safety of the driverless vehicle.

Further, based on the foregoing embodiment, the method includes:

obtain driving information of a driverless vehicle at a current time point;

calculate an orientation range of the driverless vehicle at a next time point according to a current speed orientation, an angular velocity and the preset time interval;

calculate a driving displacement of the driverless vehicle at the next time point according to the driving speed and the preset time interval;

calculate a positioning range of the driverless vehicle in the world coordinate system at the next time point according to the orientation range, the driving displacement and the positioning of the driverless vehicle in the world coordinate system, and take the positioning range in the world coordinate system as the estimated driving range;

obtain driving information of the driverless vehicle at the next time point; and

determine whether a positioning of the driverless vehicle in the world coordinate system at the next time point is within the positioning range in the world coordinate system, and perform a corresponding operation according to a determination result.

In this embodiment, after calculating the positioning range of the driverless vehicle in the world coordinate system at the next time point according to the positioning in the world coordinate system, the speed orientation, the angular velocity and the driving speed, an actual driving information of the driverless vehicle at the next time point can be obtained and whether the actual driving information is within the positioning range in the world coordinate system can be determined. If the actual driving information is within the positioning range in the world coordinate system, it indicates that the driverless vehicle is currently running normally and no positioning drift occurs. If the actual driving information is not within the positioning range in the world coordinate system, it indicates that a positioning drift occurs currently for the driverless vehicle. In order to improve the safety of driverless vehicles, it is necessary to adjust the driverless vehicle. The corresponding operation is performed according to the determination result.

The positioning drift detecting method provided in this embodiment, by determining whether a positioning of the driverless vehicle in a world coordinate system at a next time point is within a positioning range in the world coordinate system, can accurately determine whether the driverless vehicle has a positioning drift currently, and thereby improving the driving safety of the driverless vehicle.

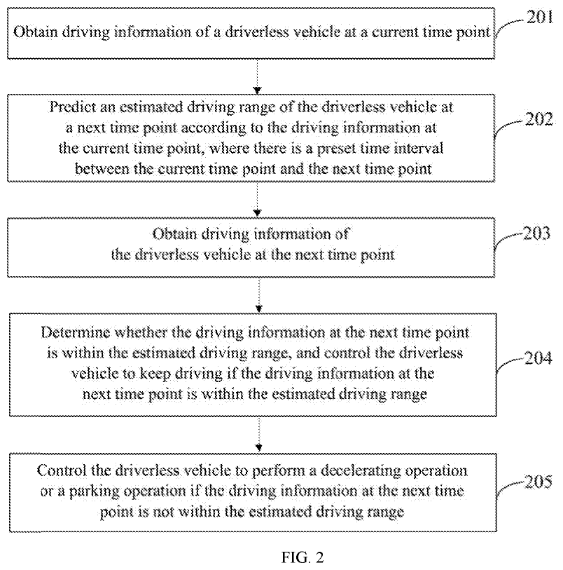

FIG. 2 is a schematic flowchart of a positioning drift detecting method according to a second embodiment of the present disclosure. Based on any of the foregoing embodiments, the method includes:

Step 201: obtain driving information of a driverless vehicle at a current time point;

Step 202: predict an estimated driving range of the driverless vehicle at a next time point according to the driving information at the current time point, where there is a preset time interval between the current time point and the next time point;

Step 203: obtain driving information of the driverless vehicle at the next time point;

Step 204: determine whether the driving information at the next time point is within the estimated driving range, control the driverless vehicle to keep driving if the driving information at the next time point is within the estimated driving range; and

Step 205: control the driverless vehicle to perform a decelerating operation or a parking operation if the driving information at the next time point is not within the estimated driving range.

In this embodiment, the driving information of the driverless vehicle at the current time point is obtained, after predicting the estimated driving range of the driverless vehicle at the next time point according to the current driving information, an actual driving information of the driverless vehicle at the next time point is obtained, and whether the actual driving information is within the estimated driving range is determined, and the corresponding operation is performed according to the determination result. Specifically, if the driving information at the next time point is within the estimated driving range, it indicates that the driverless vehicle is currently running normally and no positioning drift occurs, and thus the driverless vehicle may be controlled to keep driving. If the driving information at the next time point is not within the estimated driving range, it indicates that the driverless vehicle has a positioning drift currently. In order to improve the driving safety of the driverless vehicle, it is necessary to adjust the driverless vehicle, which may be achieved by taking an action of decelerating or parking, thereby improving the driving safety of the driverless vehicle.

The positioning drift detecting method provided in this embodiment, by determining whether driving information at a next time is within an estimated driving range, and controlling the driverless vehicle to keep driving if the driving information at the next time point is within the estimated driving range, and controlling the driverless vehicle to perform a decelerating operation or a parking operation if the driving information at the next time point is not within the estimated driving range, can improve the driving safety of the driverless vehicle.

Further, based on the foregoing embodiment, the method includes:

obtain driving information of a driverless vehicle at a current time point;

predict an estimated driving range of the driverless vehicle at a next time point according to the driving information at the current time point, where there is a preset time interval between the current time point and the next time point;

obtain driving information of the driverless vehicle at the next time point;

determine whether the driving information at the next time point is within the estimated driving range, control the driverless vehicle to keep driving if the driving information at the next time point is within the estimated driving range;

determine a current location information of the driverless vehicle if the driving information at the next time point is not within the estimated driving range; and

control the driverless vehicle to perform a decelerating operation or a parking operation according to the location information.

In this embodiment, the driving information of the driverless vehicle at the current time point is obtained, after predicting the estimated driving range of the driverless vehicle at the next time point according to the current driving information, an actual driving information of the driverless vehicle at the next time point is obtained, and whether the actual driving information is within the estimated driving range is determined, and the corresponding operation is performed according to the determination result. Specifically, if the driving information at the next time point is not within the estimated driving range, it indicates that the driverless vehicle has a positioning drift currently. In order to improve the driving safety of the driverless vehicle, it is necessary to adjust the driverless vehicle. Since the parking operation are not allowed on some road sections, for example, highways, the location information of the driverless vehicle may be determined at this time, and the driverless vehicle is controlled to perform the decelerating operation or the parking operation according to the location information. For example, if the driving information at the next time point is not within the estimated driving range, the location information of the driverless vehicle is determined. If the driverless vehicle is on a highway currently, the decelerating operation is performed, and if the driverless vehicle is on a normal road section currently, the parking operation can be performed on a roadside to adjust the driverless vehicle.

The positioning drift detecting method provided in this embodiment, by performing different adjustment operations according to a position of the driverless vehicle when driving information at a next time point is not within an estimated driving range, can improve the driving safety of the driverless vehicle.

Further, based on the foregoing embodiment, the method includes:

obtain driving information of a driverless vehicle at a current time point;

predict an estimated driving range of the driverless vehicle at a next time point according to the driving information at the current time point, where there is a preset time interval between the current time point and the next time point;

obtain driving information of the driverless vehicle at the next time point;

determine whether the driving information at the next time point is within the estimated driving range, control the driverless vehicle to keep driving if the driving information at the next time point is within the estimated driving range;

control the driverless vehicle to perform a decelerating operation if the driving information at the next time point exceeds the estimated driving range by a first threshold; and

control the driverless vehicle to perform a parking operation if the driving information at the next time point exceeds the estimated driving range by a second threshold, where the first threshold is smaller than the second threshold.

In this embodiment, the driving information of the driverless vehicle at the current time point is obtained, after predicting the estimated driving range of the driverless vehicle at the next time point according to the current driving information, an actual driving information of the driverless vehicle at the next time point is obtained, and whether the actual driving information is within the estimated driving range is determined, and the corresponding operation is performed according to the determination result. Specifically, if the driving information at the next time point is not within the estimated driving range, it indicates that the driverless vehicle has a positioning drift currently. In order to improve the driving safety of the driverless vehicle, it is necessary to adjust the driverless vehicle. If the driverless vehicle exceeds the estimated driving range by the first threshold, it indicates that a normal driving state of the driverless vehicle can be restored through an adjustment from the vehicle itself. At this time, the driverless vehicle may be controlled to perform the decelerating operation, so as to achieve an adjustment with respect to the positioning drift during the process of deceleration. If the driverless vehicle exceeds the estimated driving range by the second threshold, it indicates that the current positioning drift cannot be adjusted automatically. At this time, in order to ensure the safety of the driverless vehicle, the parking operation is required. It should be noted that the first threshold is smaller than the second threshold.

The positioning drift detecting method provided by the embodiment, by controlling the driverless vehicle to perform a parking operation or a decelerating operation according to an extent that the driverless vehicle exceeds an estimated exercise range, can improve the driving safety of the driverless vehicle on the basis of a determination that whether the driverless vehicle has a positioning drift currently.

Further, based on the foregoing embodiment, the method includes:

obtain driving information of a driverless vehicle at a current time point;

predict an estimated driving range of the driverless vehicle at a next time point according to the driving information at the current time point, where there is a preset time interval between the current time point and the next time point;

obtain driving information of the driverless vehicle at the next time point;

determine whether the driving information at the next time point is within the estimated driving range, control the driverless vehicle to keep driving if the driving information at the next time point is within the estimated driving range;

control the driverless vehicle to perform a decelerating operation if the driving information at the next time point exceeds the estimated driving range by a first threshold;

control the driverless vehicle to perform a parking operation if the driving information at the next time point exceeds the estimated driving range by a second threshold, where the first threshold is smaller than the second threshold; and

send an alarm information to cause an operation and maintenance personnel to adjust the driverless vehicle according to the alarm information.

In this embodiment, the driving information of the driverless vehicle at the current time point is obtained, after predicting the estimated driving range of the driverless vehicle at the next time point according to the current driving information, an actual driving information of the driverless vehicle at the next time point is obtained, and whether the actual driving information is within the estimated driving range is determined, and the corresponding operation is performed according to the determination result. Specifically, if the driving information at the next time point is not within the estimated driving range, it indicates that the driverless vehicle has a positioning drift currently. In order to improve the driving safety of the driverless vehicle, it is necessary to adjust the driverless vehicle. If the driverless vehicle exceeds the estimated driving range by the second threshold, it indicates that the current positioning drift cannot be adjusted automatically. At this time, in order to ensure the safety of the driverless vehicle, the parking operation is required. At this time, the alarm information may also be sent to cause the operation and maintenance personnel to adjust the driverless vehicle according to the alarm information to ensure the driving safety of the driverless vehicle.

The positioning drift detecting method provided in this embodiment, by sending an alarm information on the basis of a parking operation when the driverless vehicle exceeds an estimated driving range by a second threshold, can further improve the driving safety of the driverless vehicle.

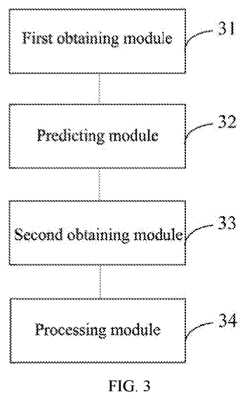

FIG. 3 is a schematic structural diagram of a positioning drift detecting apparatus according to a third embodiment of the present disclosure. As shown in FIG. 3, the apparatus includes:

a first obtaining module 31, configured to obtain driving information of a driverless vehicle at a current time point;

a predicting module 32, configured to predict an estimated driving range of the driverless vehicle at a next time point according to the driving information at the current time point, where there is a preset time interval between the current time point and the next time point;

a second obtaining module 33, configured to obtain driving information of the driverless vehicle at the next time point;

a processing module 34, configured to determine whether the driving information at the next time point is within the estimated driving range, and perform a corresponding operation according to a determination result.

The positioning drift detecting apparatus provided by the embodiment, by obtaining driving information of a driverless vehicle at a current time point; predicting an estimated driving range of the driverless vehicle at a next time point according to the driving information at the current time point, where there is a preset time interval between the current time point and the next time point; obtaining driving information of the driverless vehicle at the next time point; and determining whether the driving information at the next time point is within the estimated driving range, and performing a corresponding operation according to a determination result, can accurately determine whether or not a drift occurs currently, thereby preventing the driving accident of the driverless vehicle and improving a driving safety of the driverless vehicle.

Specifically, the driving information includes positioning of the driverless vehicle in a world coordinate system, a speed orientation, an angular velocity and a driving speed of the driverless vehicle. Based on the foregoing embodiment, the apparatus includes:

a first obtaining module, configured to obtain driving information of a driverless vehicle at a current time point;

a predicting module includes:

an orientation range calculating unit, configured to calculate an orientation range of the driverless vehicle at a next time point according to a current speed orientation, an angular velocity and the preset time interval;

a driving displacement calculating unit, configured to calculate a driving displacement of the driverless vehicle at the next time point according to the driving speed and the preset time interval;

an estimated driving range calculating unit, configured to calculate a positioning range of the driverless vehicle in the world coordinate system at the next time point according to the orientation range, the driving displacement and the positioning of the driverless vehicle in the world coordinate system, and take the positioning range in the world coordinate system as the estimated driving range;

a second obtaining module, configured to obtain driving information of the driverless vehicle at the next time point;

a processing module, configured to determine whether the driving information at the next time point is within the estimated driving range, and perform a corresponding operation according to a determination result.

The positioning drift detecting apparatus provided by the embodiment, by calculating an estimated driving range of the driverless vehicle at a next time point according to a positioning in a world coordinate system, a speed orientation, an angular velocity and a driving speed, can accurately determine whether the driverless vehicle has a positioning drift currently and improving the driving safety of the driverless vehicle.

Further, based on the foregoing embodiment, the apparatus includes:

a first obtaining module, configured to obtain driving information of a driverless vehicle at a current time point;

a predicting module includes:

an orientation range calculating unit, configured to calculate an orientation range of the driverless vehicle at a next time point according to a current speed orientation, an angular velocity and the preset time interval;

a driving displacement calculating unit, configured to calculate a driving displacement of the driverless vehicle at the next time point according to the driving speed and the preset time interval;

an estimated driving range calculating unit, configured to calculate a positioning range of the driverless vehicle in the world coordinate system at the next time point according to the orientation range, the driving displacement and the positioning of the driverless vehicle in the world coordinate system, and take the positioning range in the world coordinate system as the estimated driving range;

a second obtaining module, configured to obtain driving information of the driverless vehicle at the next time point;

a processing module includes:

a determining unit, configured to determine whether a positioning of the driverless vehicle in the world coordinate system at the next time point is within the positioning range in the world coordinate system, and perform a corresponding operation according to a determination result.

The positioning drift detecting apparatus provided in this embodiment, by determining whether a positioning of the driverless vehicle in a world coordinate system at a next time point is within a positioning range in the world coordinate system, can accurately determine whether the driverless vehicle has a positioning drift currently, and thereby improving the driving safety of the driverless vehicle.

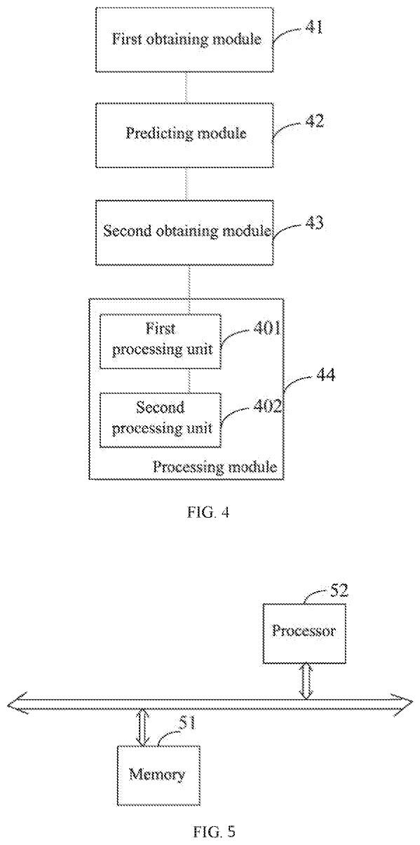

FIG. 4 is a schematic structural diagram of a positioning drift detecting apparatus according to a fourth embodiment of the present disclosure. Based on any of the foregoing embodiments, as shown in FIG. 4, the apparatus includes:

a first obtaining module 41, configured to obtain driving information of a driverless vehicle at a current time point;

a predicting module 42, configured to predict an estimated driving range of the driverless vehicle at a next time point according to the driving information at the current time point, where there is a preset time interval between the current time point and the next time point;

a second obtaining module 43, configured to obtain driving information of the driverless vehicle at the next time point;

a processing module 44, including:

a first processing unit 401, configured to determine whether the driving information at the next time point is within the estimated driving range, control the driverless vehicle to keep driving if the driving information at the next time point is within the estimated driving range; and

a second processing unit 402, configured to control the driverless vehicle to perform a decelerating operation or a parking operation if the driving information at the next time point is not within the estimated driving range.

The positioning drift detecting apparatus provided in this embodiment, by determining whether driving information at a next time is within an estimated driving range, and controlling the driverless vehicle to keep driving if the driving information at the next time point is within the estimated driving range, and controlling the driverless vehicle to perform a decelerating operation or a parking operation if the driving information at the next time point is not within the estimated driving range, can improve the driving safety of the driverless vehicle.

Further, based on the foregoing embodiment, the apparatus includes:

a first obtaining module, configured to obtain driving information of a driverless vehicle at a current time point;

a predicting module, configured to predict an estimated driving range of the driverless vehicle at a next time point according to the driving information at the current time point, where there is a preset time interval between the current time point and the next time point;

a second obtaining module, configured to obtain driving information of the driverless vehicle at the next time point;

a processing module, including:

a first processing unit, configured to determine whether the driving information at the next time point is within the estimated driving range, control the driverless vehicle to keep driving if the driving information at the next time point is within the estimated driving range;

a second processing unit, including:

a location information determining subunit, configured to determine a current location information of the driverless vehicle if the driving information at the next time point is not within the estimated driving range; and

a controlling subunit, configured to control the driverless vehicle to perform a decelerating operation or a parking operation according to the location information.

The positioning drift detecting apparatus provided in this embodiment, by performing different adjustment operations according to a position of the driverless vehicle when driving information at a next time point is not within an estimated driving range, can improve the driving safety of the driverless vehicle.

Further, based on the foregoing embodiment, the apparatus includes:

a first obtaining module, configured to obtain driving information of a driverless vehicle at a current time point;

a predicting module, configured to predict an estimated driving range of the driverless vehicle at a next time point according to the driving information at the current time point, where there is a preset time interval between the current time point and the next time point;

a second obtaining module, configured to obtain driving information of the driverless vehicle at the next time point;

a processing module, including:

a first processing unit, configured to determine whether the driving information at the next time point is within the estimated driving range, control the driverless vehicle to keep driving if the driving information at the next time point is within the estimated driving range;

a second processing unit, including:

a first controlling subunit, configured to control the driverless vehicle to perform a decelerating operation if the driving information at the next time point exceeds the estimated driving range by a first threshold; and

a second controlling subunit, configured to control the driverless vehicle to perform a parking operation if the driving information at the next time point exceeds the estimated driving range by a second threshold, where the first threshold is smaller than the second threshold.

The positioning drift detecting apparatus provided by the embodiment, by controlling the driverless vehicle to perform a parking operation or a decelerating operation according to an extent that the driverless vehicle exceeds an estimated exercise range, can improve the driving safety of the driverless vehicle on the basis of a determination that whether the driverless vehicle has a positioning drift currently.

Further, based on the foregoing embodiment, the apparatus includes:

a first obtaining module, configured to obtain driving information of a driverless vehicle at a current time point;

a predicting module, configured to predict an estimated driving range of the driverless vehicle at a next time point according to the driving information at the current time point, where there is a preset time interval between the current time point and the next time point;

a second obtaining module, configured to obtain driving information of the driverless vehicle at the next time point;

a processing module, including:

a first processing unit, configured to determine whether the driving information at the next time point is within the estimated driving range, control the driverless vehicle to keep driving if the driving information at the next time point is within the estimated driving range;

a second processing unit, including:

a first controlling subunit, configured to control the driverless vehicle to perform a decelerating operation if the driving information at the next time point exceeds the estimated driving range by a first threshold;

a second controlling subunit, configured to control the driverless vehicle to perform a parking operation if the driving information at the next time point exceeds the estimated driving range by a second threshold, where the first threshold is smaller than the second threshold; and

an alarming unit, configured to send an alarm information to cause an operation and maintenance personnel to adjust the driverless vehicle according to the alarm information.

The positioning drift detecting apparatus provided in this embodiment, by sending an alarm information on the basis of a parking operation when the driverless vehicle exceeds an estimated driving range by a second threshold, can further improve the driving safety of the driverless vehicle.

FIG. 5 is a schematic structural diagram of a positioning drift detecting device according to a fifth embodiment of the present disclosure. As shown in FIG. 5, the positioning drift detecting device includes: a memory 51, a processor 52;

the memory 51 is configured to store instructions that are executable by the processor 52;

where the processor 52 is configured to perform the positioning drift detecting method as described above.

Yet another embodiment of the present disclosure provides a computer readable storage medium, where the computer readable storage medium stores computer executable instructions, the computer executable instructions are configured to implement the positioning drift detecting method as described above when being executed by a processor.

A person skilled in the art can clearly understand that, for the convenience and brevity of the description, the specific implementation process of the above apparatus can refer to the corresponding process in the foregoing method embodiments, and details are not repeated herein.

Those of ordinary skill in the art will appreciate that all or part of the steps in each method embodiment may be implemented through program instruction-related hardware. The aforementioned program may be stored in a computer readable storage medium. The program, when executed, performs steps including those in the foregoing method embodiments; and the foregoing storage medium includes various media that can store program codes, such as a ROM, a RAM, a magnetic disk, or an optical disk.

At last, it should be noted that the above embodiments are merely illustrative of the technical solutions of the present disclosure, and are not intended to be limiting. Although the present disclosure has been described in detail with reference to the foregoing embodiments, those skilled in the art will understand that the technical solutions described in the foregoing embodiments may be modified, or that some or all of the technical features may be equivalently substituted; these modifications or substitutions do not deviate the nature of the corresponding technical solution from the scope of the technical solutions of various embodiments according to the present disclosure.

What is claimed is:

1. A positioning drift detecting method, comprising:
a) obtaining driving information of a driverless vehicle at a current time point;
b) predicting an estimated driving range of the driverless vehicle at a next time point according to the driving information at the current time point, wherein there is a preset time interval between the current time point and the next time point;
c) obtaining driving information of the driverless vehicle at the next time point; and
d) determining whether the driving information at the next time point is within the estimated driving range, and performing a corresponding operation according to a determination result.

2. The method according to claim 1, wherein the driving information comprises a positioning of the driverless vehicle in a world coordinate system, a speed orientation, an angular velocity and a driving speed; and predicting an estimated driving range of the driverless vehicle at a next time point according to the driving information at the current time point comprises: calculating an orientation range of the driverless vehicle at the next time point according to a current speed orientation, an angular velocity and the preset time interval; calculating a driving displacement of the driverless vehicle at the next time point according to the driving speed and the preset time interval; and calculating a positioning range of the driverless vehicle in the world coordinate system at the next time point according to the orientation range, the driving displacement and the positioning of the driverless vehicle in the world coordinate system, and taking the positioning range in the world coordinate system as the estimated driving range.

3. The method according to claim 2, wherein the determining whether the driving information at the next time point is within the estimated driving range comprises: determining whether a positioning of the driverless vehicle in the world coordinate system at the next time point the world coordinate system is within the positioning range in the world coordinate system.

4. The method according to claim 1, wherein the performing a corresponding operation according to a determination result comprises: controlling the driverless vehicle to keep driving if the driving information at the next time point is within the estimated driving range.

5. The method according to claim 1, wherein the performing a corresponding operation according to a determination result comprises: controlling the driverless vehicle to perform a decelerating operation or a parking operation if the driving information at the next time point is not within the estimated driving range.

6. The method according to claim 5, wherein the controlling the driverless vehicle to perform a decelerating operation or a parking operation if the driving information at the next time point is not within the estimated driving range comprises: determining a current location information of the driverless vehicle if the driving information at the next time point is not within the estimated driving range; and controlling the driverless vehicle to perform the decelerating operation or the parking operation according to the location information.

7. The method according to claim 6, wherein the controlling the driverless vehicle to perform a decelerating operation or a parking operation if the driving information at the next time point is not within the estimated driving range comprises: controlling the driverless vehicle to perform the decelerating operation if the driving information at the next time point exceeds the estimated driving range by a first threshold.

8. The method according to claim 6, wherein the controlling the driverless vehicle to perform a decelerating operation or a parking operation if the driving information at the next time point is not within the estimated driving range comprises: controlling the driverless vehicle to perform the parking operation if the driving information at the next time point exceeds the estimated driving range by a second threshold, wherein the first threshold is smaller than the second threshold.

9. The method according to claim 6, wherein after the controlling the driverless vehicle to perform a decelerating operation or a parking operation if the driving information at the next time point is not within the estimated driving range, the method further comprises: sending an alarm information to cause an operation and maintenance personnel to adjust the driverless vehicle according to the alarm information.

10. A positioning drift detecting apparatus, comprising:
a) a memory, a processor, and a computer program stored on the memory and operable on the processor,
b) wherein the processor, when running the computer program, is configured to:
c) obtain driving information of a driverless vehicle at a current time point;
d) predict an estimated driving range of the driverless vehicle at a next time point according to the driving information at the current time point, wherein there is a preset time interval between the current time point and the next time point;
e) obtain driving information of the driverless vehicle at the next time point; and
f) determine whether the driving information at the next time point is within the estimated driving range, and performing a corresponding operation according to a determination result.

11. The apparatus according to claim 10, wherein the driving information comprises a positioning of the driverless vehicle in a world coordinate system, a speed orientation, an angular velocity and a driving speed; and the processor is further configured to: calculate an orientation range of the driverless vehicle at a next time point according to a current speed orientation, an angular velocity and the preset time interval; calculate a driving displacement of the driverless vehicle at the next time point according to the driving speed and the preset time interval; and calculate a positioning range of the driverless vehicle in the world coordinate system at the next time point according to the orientation range, the driving displacement and the positioning of the driverless vehicle in the world coordinate system, and take the positioning range in the world coordinate system as the estimated driving range.

12. The apparatus according to claim 11, wherein the processor is further configured to: determine whether a positioning of the driverless vehicle in the world coordinate system at the next time point the world coordinate system is within the positioning range in the world coordinate system.

13. The apparatus according to claim 10, wherein the processor is further configured to: control the driverless vehicle to keep driving if the driving information at the next time point is within the estimated driving range.

14. The apparatus according to claim 10, wherein the processor is further configured to: control the driverless vehicle to perform a decelerating operation or a parking operation if the driving information at the next time point is not within the estimated driving range.

15. The apparatus according to claim 14, wherein the processor is further configured to: determine a current location information of the driverless vehicle if the driving information at the next time point is not within the estimated driving range.

16. The apparatus according to claim 15, wherein the processor is further configured to: control the driverless vehicle to perform the decelerating operation or the parking operation according to the location information.

17. The apparatus according to claim 14, wherein the processor is further configured to: control the driverless vehicle to perform the decelerating operation if the driving information at the next time point exceeds the estimated driving range by a first threshold.

18. The apparatus according to claim 14, wherein the processor is further configured to: control the driverless vehicle to perform the parking operation if the driving information at the next time point exceeds the estimated driving range by a second threshold, wherein the first threshold is smaller than the second threshold.

19. The apparatus according to claim 14, wherein the processor is further configured to: send an alarm information to cause an operation and maintenance personnel to adjust the driverless vehicle according to the alarm information.

20. A computer readable storage medium, wherein the computer readable storage medium stores computer executable instructions, the computer executable instructions are configured to implement a positioning drift detecting method when being executed by a processor; wherein the positioning drift detecting method comprises the steps of:
a) obtaining driving information of a driverless vehicle at a current time point;
b) predicting an estimated driving range of the driverless vehicle at a next time point according to the driving information at the current time point, wherein there is a preset time interval between the current time point and the next time point;
c) obtaining driving information of the driverless vehicle at the next time point; and
d) determining whether the driving information at the next time point is within the estimated driving range, and performing a corresponding operation according to a determination result.
